(19) United States
(12) Patent Application Publication
(10) Pub. No.: US 2014/0186611 A1
(43) Pub. Date: Jul. 3, 2014

(54) POLYOL FORMULATIONS FOR IMPROVED GREEN STRENGTH OF POLYISOCYANURATE RIGID FOAMS

(71) Applicant: DOW GLOBAL TECHNOLOGIES LLC, Midland, MI (US)

(72) Inventors: Michael J. Skowronski, Marietta, GA (US); Kelly R. Flaherty, New Albany, OH (US); Jorge Jimenez, Lake Jackson, TX (US); Woo-Sung Bae, Midland, MI (US); Giuseppe Lista, Modena (IT)

(73) Assignee: DOW GLOBAL TECHNOLOGIES LLC, Midland, MI (US)

(21) Appl. No.: 14/119,199

(22) PCT Filed: May 21, 2012
(86) PCT No.: PCT/US2012/038808

§ 371 Date: Nov. 21, 2013

Related U.S. Application Data
(60) Provisional application No. 61/502,429, filed on Jun. 29, 2011.

(51) Int. Cl. C08G 63/668; B32B 5/20; C08G 18/00

(52) U.S. Cl. CPC C08G 63/668; C08G 18/00; B32B 5/20
USPC 428/304.4; 528/308.7; 521/155; 521/174

(57) ABSTRACT

Polyesters and polyol formulations comprising polyesters used in the preparation of polyisocyanurate rigid foams with improved green strength properties are provided. In some embodiments, a polyester which is the reaction product of (a) an aromatic component comprising 80 mole percent or greater of terephthalic acid, (b) at least one polyether polyol having a nominal functionality of 2, a molecular weight of 150 to 1,000 and a polyoxyethylene content of at least 70% by weight of the polyether polyol, (c) at least one glycol different than (b) having a nominal functionality of 2 and a molecular weight from 60 to 250, and (d) at least one polyol having a molecular weight of 60 to 250 and a nominal functionality of at least 3, wherein (a), (b), (c), and (d) are present in the reaction on a percent weight basis of 20 to 60 weight percent of (a), 20 to 50 weight percent of (b), 10 to 30 weight percent of (c), and 5 to 20 weight percent of (d) is provided.

### BACKGROUND OF THE INVENTION

1. Field of the Invention

Embodiments of the invention relate to a polyol formulation comprising certain polyester polyols used in the preparation of polyisocyanurate rigid foams. Such foams are particularly useful in producing composite elements.

2. Description of the Related Art

Polyisocyanurate foams have the ability to be tailored to particular applications through the selection of the raw materials that are used to form the polymer. Rigid types of polyisocyanurate foams are used as appliance insulation foams and other thermal insulating applications.

Rigid polyisocyanurate foams may be produced using either a continuous process or a discontinuous process. In a continuous process, also called a double belt lamination (DBL) process, typically two “facings”, in the form of continuous facing sheets, are positioned parallel to each other, with one above the other. The facings are driven to a conveyor, which has the purpose of both heating the facings and maintaining the facings in position. Just before entering the conveyor, an amount of the formulation for the foam layer is transferred onto the lower facing, so that the rising foam is sandwiched between the lower and upper facing. The foam is further constrained on the sides, i.e., lateral containment. The polymerization process, which includes foaming, is completed as the material moves along the conveyor. After exiting the conveyor, the panels are cut to desired lengths. In some continuous processes, a single facing sheet is used with the conveyor functioning as the second facing sheet with the foam layer formed between the single facing sheet and the conveyor.

Green strength is a measure of the initial strength properties of the demolded material. In the DBL process, the line speed of the conveyor is limited by the reactivity profile and the green strength of the panel at the end of the manufacturing line. If the line speed is too high for a formulation, the green strength at the end of the line will be reduced, which may result in unacceptable post-expansion of the panel at the end of the production line and other undesirable effects including shrinkage, deformation, and damage due to stacking and handling. Attempts to increase the green strength and corresponding line speed have included increasing the catalyst level of the formulation. However, increasing the catalyst level has been found to reduce the cream time and gel time, which may have deleterious effects during foam formation.

### SUMMARY OF THE INVENTION

Embodiments of the invention relate to certain polyols, a polyol formulation comprising such polyols used in the preparation of polyisocyanurate rigid foams with improved green strength properties, and the foams produced from such formulations. In one embodiment, a polyester is provided. The polyester is the reaction product of at least:

(a) an aromatic component comprising 80 mole percent or greater of terephthalic acid;

(b) at least one polyether polyol having a nominal functionality of 2, a molecular weight of 150 to 1,000 and a polyoxyethylene content of at least 70% by weight of the polyether polyol;

(c) at least one glycol different than (b) having a nominal functionality of 2 and a molecular weight from 60 to 250; and

(d) at least one polyol having a molecular weight of 60 to 250 and a nominal functionality of at least 3;

wherein a, b, c, and d are present in the reaction on a percent weight basis of 20 to 60 weight percent of (a), 20 to 50 weight percent of (b), 10 to 30 weight percent of (c), and 5 to 20 weight percent of (d).

In another embodiment, a polyol formulation is provided wherein the polyol formulation comprises:

a first polyol which is the polyester polyol as described above;

at least one second polyether polyol having a functionality of 2 to 8 and a molecular weight of 100 to 2,000; and

wherein the first to second polyol are present in a weight percent of the polyol mixture from 20 to 90 weight percent of the first polyol and 10 to 80 weight percent of the second polyol.

In another embodiment, a reaction system for production of a polyisocyanurate rigid foam is provided. The reaction system comprises:

(A) a polyol formulation comprising:
(1) a polyester as described above;

(B) a polyisocyanate component,

(C) blowing agents;

(D) catalysts; and

(E) optionally additives and auxiliaries.

In another embodiment, a reaction system for production of a polyisocyanurate rigid foam is provided. The reaction system comprises:

A) a polyol formulation comprising
a first polyol which is the polyester polyol as described above;
at least one second polyether polyol having a functionality of 2 to 8 and a molecular weight of 100 to 2,000; and
wherein the first and second polyol are present in a weight percent of the polyol mixture from 20 to 90 weight percent of the first polyol and 10 to 80 weight percent of the second polyol:

(B) a polyisocyanate component,

(C) blowing agents;

(D) catalysts; and

(E) optionally additives and auxiliaries.

In yet another embodiment, a process for preparing a rigid polyisocyanurate foam is provided. The process comprises:

a. forming a reaction system containing at least:
1. a polyol formulation as described above;
2. a polyisocyanate component; and
3. at least one hydrocarbon, hydrofluorocarbon, hydrochlorofluorocarbon, fluorocarbon, dialkyl ether or fluorine-substituted dialkyl ether physical blowing agent;
4. catalysts;
5 optionally additives and auxiliaries and

b. subjecting the reaction system to conditions such that the reaction system expands and cures to form a rigid polyisocyanurate foam.

In yet another embodiment, a composite element is provided. The composite element comprises:

i) a facing layer;

ii) a rigid foam comprising the reaction product of:
(A) a polyol formulation as described above: and
(B) a polyisocyanate component;
(C) blowing agents;
(D) catalysts;
(E) optionally additives and auxiliaries and

iii) optionally a second facing layer.

In another embodiment a process for preparing a composite element wherein the rigid foam (ii) adheres to (i) and (iii) and is prepared between (i) and (iii) by reacting the isocyanate and polyol formulation at a temperature of 25° C. to 70° C. is provided.

In further embodiments, such optional additives or auxiliaries are selected from the groups consisting of dyes, pigments, internal mold release agents, fire retardants, fillers, reinforcements, plasticizers, smoke suppressants, fragrances, antistatic agents, biocides, antioxidants, light stabilizers, adhesion promoters, surfactants and combinations of these.

### DETAILED DESCRIPTION

Embodiments of the invention relate to polyester polyols, polyol formulations comprising such polyester polyols, and the use of such polyol formulations in the preparation of polyisocyanurate rigid foams having improved green strength. Such foams are particularly useful in producing composite elements.

The use of a polyol formulation in preparation of polyisocyanurates by reaction of the polyol formulation with a polyisocyanate in the presence of a catalyst and perhaps other ingredients is well known. Aromatic polyester polyols, such as those based on dimethyl terephthalate (DMT) process residue, are widely used in the manufacture of flame rated rigid polyisocyanurate panels to aid in flammability performance of the foams. Typical formulations using these aromatic polyester polyols show a tendency toward poor green strength and decreased production line speed. Attempts to modify the DMT-based polyisocyanurate formulations to improve the green strength have resulted in other negative consequences in terms of the processing and/or properties of the foam.

Polyol formulations containing the terephthalic acid-based polyester polyols described herein have resulted in a polyisocyanurate foam having a similar reactive profile but a higher green strength during the typical time frame in which a double-faced panel would be processing through a double-belt laminating system (e.g., less than 8 minutes). This higher green strength at similar reactivity results in a panel having an increased ‘hardness’ at the end of the production line with reduced potential for post-expansion, shrinkage, and deformation and damage from stacking and handling.

The polyester of the present invention is the reaction product of at least a) an aromatic component; b) at least one polyether polyol having a nominal functionality of 2 and a polyoxyethylene content of at least 70% by weight of the polyether polyol; c) at least one glycol different than (b) having a nominal functionality of 2 and a molecular weight from 60 to 250 and d) at least one polyol having a molecular weight of 60 to 250 and a nominal functionality of at least 3. It was found that such polyesters can be used to produce polyisocyanurate foams having improved green strength.

The aromatic component (a) of the present polyester is primarily derived from terephthalic acid. Terephthalic acid will generally comprise 80 mole percent or more of the aromatic component (a). In further embodiments, terephthalic acid will comprise 85 mole percent or more of the aromatic component (a). In another embodiment, terephthalic acid will comprise 90 mole percent or more of the aromatic component (a) for making the polyester. In another embodiment, the aromatic component (a) comprises greater than 95 mole percent terephthalic acid. In another embodiment, the aromatic component (a) is essentially derived from terephthalic acid. While the polyester may be prepared from substantially pure terephthalic acid, more complex ingredients can be used, such as the side-stream, waste or scrap residues from the manufacture of terephthalic acid. Other types of aromatic materials which may be present include, for example, phthalic anhydride, trimellitic anhydride, dimethyl terephthalic residues.

The aromatic component (a) may comprise at least 20 wt. %, 25 wt. %, 30 wt. %, 35 wt. %, 40 wt. %, 45 wt. %, 50 wt. %, or 55 wt. % of the total reaction or reaction mixture. The aromatic component (a) may comprise up to 25 wt. %, 30 wt. %, 35 wt. %, 40 wt. %, 45 wt. %, 50 wt. %, 55 wt. %, or 60 wt. % of the total reaction. In certain embodiments, the aromatic component (a) may comprise from 20 wt. % to 60 wt. % of the total reaction. In a further embodiment, the aromatic component (a) comprises 30 wt. % or greater of the reaction. In yet a further embodiment, the aromatic component (a) comprises 35 wt. % or more of the reaction.

The polyether polyol component (b) may be obtained by the alkoxylation of suitable starting molecules (initiators) with a C₂ to C₄ alkylene oxide, such as ethylene oxide, propylene oxide, 1,2-butylene oxide, 2,3-butylene oxide, tetramethylene oxide or a combination of two or more thereof. The polyether polyol component (b) will generally contain greater than 70% by weight of oxyalkylene units derived from ethylene oxide (EO) units and preferably at least 75% by weight of oxyalkylene units derived from EO. In other embodiments, the polyether polyol component (b) will contain greater than 80 wt. % of oxyalkylene units derived from EO and in a further embodiment, 85 wt. % or more of the oxyalkylene units will be derived from EO. In some embodiments, ethylene oxide will be the sole alkylene oxide used in the production of the polyol. When an alkylene oxide other than EO is used, it is preferred that the additional alkylene oxide, such as propylene or butylene oxide is fed as a co-feed with the EO or fed as an internal block. Catalysis for this polymerization can be either anionic or cationic, with catalysts such as potassium hydroxide, cesium hydroxide, boron trifluoride, or a double cyanide complex (DMC) catalyst such as zinc hexacyanocobaltate or quaternary phosphazenium compound. In the case of alkaline catalysts, these alkaline catalysts are preferably removed from the polyol at the end of production by a proper finishing step, such as coalescence, magnesium silicate separation or acid neutralization.

The polyether polyol component (b), generally has a molecular weight of from 150 to 1,000. In one embodiment, the number average molecular weight is 160 or greater. In a further embodiment, the number average molecular weight is less than 800, or even less than 600. In a further embodiment, the number average molecular weight is less than 500.

The initiators for production of the polyether polyol component (b) have a functionality of 2. As used herein, unless otherwise stated, the functionality refers to the nominal functionality. Non-limiting examples of such initiators include, for example, ethylene glycol, diethylene glycol, propylene glycol, water and combinations thereof.

The polyether polyol component (b) may comprise at least 20 wt. %, 25 wt. %, 30 wt. %, 35 wt. %, 40 wt. %, or 45 wt. % of the total reaction. The polyether polyol component (b) may comprise up to 25 wt. %, 30 wt. %, 35 wt. %, 40 wt. %, 45 wt. %, or 50 wt. % of the total reaction. In certain embodiments, the polyether polyol component (b) may comprise from 20 wt. % to 50 wt. % of the total reaction. The polyether polyol component (b) generally comprises from 20 to 50 weight percent of the total reaction. In a further embodiment, the polyether polyol component (b) will comprise from 30 to 50 wt. % of the total reaction. In another embodiment, the polyether polyol component (b) will comprise at least 35 wt. % of the total reaction.

In addition to the aromatic component (a) and the polyether polyol component (b), the reaction for producing the polyester further contains one or more glycols having a molecular weight of 60 to 250 (component c) which is different from (b). Such glycol, or blend of glycols, will generally have a nominal functionality of 2.

In one embodiment, 2 functional glycols of component (c) may be represented by the formula:

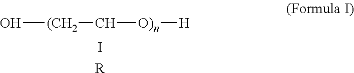

where R is hydrogen or a lower alkyl of 1 to 4 carbon atoms and n is selected to give a molecular weight of 250 or less. In a further embodiment n is selected to give a molecular weight of less than 200. In a further embodiment, R is hydrogen. Non-limiting examples of glycols which can be used in the present invention include ethylene glycol, diethylene glycol, and other polyethylene glycols, propylene glycol, dipropylene glycol, etc.

Component (c) may comprise at least 10 wt. %, 12 wt %, 15 wt. %, 18 wt. %, 20 wt. %, or 25 wt. % of the total reaction. Component (c) may comprise up to 12 wt. %, 15 wt. %, 18 wt. %, 20 wt. %, 25 wt % or 30 wt % of the total reaction. Component (c) will generally comprise at least 10 weight percent of the reaction and generally less than 30 weight of the reaction for making the polyester.

The reaction for producing the polyester may further contain a polyol having a nominal functionality of 3 or greater and a molecular weight of 60 to 250 (component d). Three functional polyols include, for example glycerin and trimethylolpropane. Higher functional polyols include, for example, pentaerythritol.

Component (d) may comprise at least 5 wt. %, 7 wt. %, 10 wt. %, 15 wt. %, or 18 wt. % of the total reaction. Component (d) may comprise up to 7 wt. %, 10 wt. %, 15 wt. %, 18 wt. %, or 20 wt. % of the total reaction. Component (d) may generally comprise at least 5 weight percent of the reaction and generally less than 20 weight of the total reaction for making the polyester. In another embodiment, the glycol component (d) will comprise greater than 7 wt. % of the total reaction. In a further embodiment, the glycol component (d) will be less than 18 wt. % of the total reaction.

Based on the components in making the polyester, the polyester will have a nominal functionality greater than 2.3 and generally no greater than 2.7. In a further embodiment the polyester has a functionality of 2.5 or less, for example, a functionality of 2.4. The amount of materials used in making the polyester will generally provide for a polyester having a hydroxyl number of from 200 to 400. In further embodiments the hydroxyl number of the polyester is less than 350.

By inclusion of a specified amount of polyethylene oxide based polyether polyol along with other components as specified above, along with the aromatic component, the viscosity of the resulting polyester is generally less than 15,000 cps (mPa*s) at 25° C. as measured by UNI EN ISO 3219. In a further embodiment the viscosity of the polyester is less than 10,000 cps (mPa*s). While it is desirable to have a polyester with as low a viscosity as possible, due to practical chemical limitations and end-use applications, the viscosity of the polyester will generally be greater than 1,000 cps (mPa*s).

A polyester of the invention may include any minor amounts of unreacted glycol remaining after the preparation of the polyester. Although not desired, the polyester can include up to about 30 weight percent free glycol/polyols. The free glycol content of the polyester of the invention generally is from about 0 to about 30 weight percent, and usually from 1 to about 25 weight percent, based on the total weight of the polyester. The polyester may also include small amounts of residual, non-inter-esterified aromatic component. Typically the non-inter-esterified aromatic materials will be present in an amount less than 2 percent by weight based on the total weight of the components combined to form the polyester of the invention.

The polyester may be formed by the polycondensation/transesterification and polymerization of components (a), (b), (c) and (d) under conditions well known in the art. See for Example G. Oertel, Polyurethane Handbook, Carl Hanser Verlag, Munich, Germany 1985, pp 54-62 and Mihail Ionescu, Chemistry and Technology of Polyols for Polyurethanes, Rapra Technology, 2005, pp 263-294. In general, the synthesis is done at temperature of 180 to 280° C. In another embodiment the synthesis is done at a temperature of at least 200° C. In a further embodiment the synthesis is done at a temperature of 215° C. or greater. In a further embodiment the synthesis is done at a temperature of 260° C. or less.

While the synthesis may take place under reduced or increased pressure, the reaction is generally carried out near atmospheric pressure conditions.

While the synthesis may take place in the absence of a catalyst, catalysts which promote the esterification/transesterification/polymerization reaction may be used. Examples of such catalysts include tetrabutyltitanate, dibutyl tin oxide, potassium methoxide, or oxides of zinc, lead or antimony; titanium compounds such as titanium (IV) isopropoxide and titanium acetylacetonate. When used, such catalyst is used in an amount of 0.005 to 1 weight percent of the reaction. In further embodiments the catalyst is present in an amount of from 0.005 to 0.5 weight percent of the total reaction.

The volatile product(s) of the reaction, for example water and/or methanol, is generally taken off overhead in the process and forces the ester interchange reaction to completion.

The synthesis usually takes from one to five hours. The actual length of time required varies, of course; with catalyst concentration, temperature etc. In general, it is desired not to have too long a polymerization cycle, both for economic reasons and for the reason that if the polymerization cycle is too long, thermal degradation may occur.

The polyester described herein may be part of a polyol formulation for making various polyisocyanurate products. The polyol formulation, also referred to as the isocyanate-reactive component, along with an isocyanate component make-up a reaction system for producing a polyisocyanurate foam. Depending on the application, the polyester will generally range from 20 to 90 wt. % of the total polyol formulation. The polyester may comprise at least 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the total polyol formulation. The polyester may comprise up to 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, or 100 wt. % of the total polyol formulation. The amount of the polyester which can be used for particular applications can be readily determined by those skilled in the art.

Other representative polyols useful in the polyol formulation may include polyether polyols, polyester polyols different from the polyester of the present invention, polyhydroxy-terminated acetal resins, and hydroxyl-terminated amines. Alternative polyols that may be used include polyalkylene carbonate-based polyols and polyphosphate-based polyols. Polyether or polyester polyols are preferred. Polyether polyols prepared by adding an alkylene oxide, such as ethylene oxide, propylene oxide, butylene oxide or a combination thereof, to an initiator having from 2 to 8 active hydrogen atoms. The functionality of polyol(s) used in the polyol formulation will depend on the end use application as known to those skilled in the art. Such polyols advantageously have a functionality of at least 2, preferably 3, and up to 8, preferably up to 6, active hydrogen atoms per molecule. The polyols used for rigid foams generally have a hydroxyl number of about 200 to about 1,200 and more preferably from about 250 to about 800.

Polyols that are derived from renewable resources such as vegetable oils or animal fats may also be used as additional polyols. Examples of such polyols include castor oil, hydroxymethylated polyesters as described in WO 04/096882 and WO 04/096883, hydroxymethylated polyols as described in U.S. Pat. Nos. 4,423,162; 4,496,487 and 4,543,369 and “blown” vegetable oils as described in US Published Patent Applications 2002/0121328, 2002/0119321 and 2002/0090488.

To increase cross-linking network the polyol formulation may contain a higher functional polyol having a functionality of 4 to 8. Initiators for such polyols include, for example, pentaerythritol, sorbitol, sucrose, glucose, fructose or other sugars, and the like. Such higher functional polyols will have an average hydroxyl number from about 200 to about 850, preferably from about 300 to about 770. Other initiators may be added to the higher functional polyols, such a glycerin to give co-initiated polyols functionality of from 4.1 to 7 hydroxyl groups per molecule and a hydroxyl equivalent weight of 100 to 175. When used, such polyols will generally comprise from 10 to 50 wt. % of the polyol formulation for making a rigid foam, depending on the particular application.

The polyol formulation may contain up to 20% by weight of still another polyol, which is not the polyester, an amine-initiated polyol or a higher functional polyol and which has a hydroxyl functionality of 2.0 to 5.0 and a hydroxyl equivalent weight of from 90 to 600.

For construction applications, the polyol formulation may also include a polyol formed alkoxylation product of a phenol-formaldehyde resin. Such polyols are known in the art as Novolac polyols. When used in a polyol formulation, the Novolac polyols can be present in an amount of up 20 wt. % of the total polyol formulation.

In one embodiment, the invention provides a polyol formulation comprising from 30 to 80 weight percent of a polyester as described above and the remainder is at least one polyol or a combination of polyols having a functionality of 2 to 8 and molecular weight of 100 to 10,000. The at least one polyol may have a functionality of 2 to 8 and a molecular weight of 100 to 2,000.

Specific examples of polyol formulation suitable for producing a rigid foam for construction applications having improved green strength include a mixture of from 20 to 90% by weight of the polyester of the present invention; from 10 to 80% by weight of sorbitol or sucrose/glycerin initiated polyether polyol wherein the polyol or polyol blend has a functionality of 3 to 8 and a hydroxyl equivalent weight of 200 to 850, and if present up to 20% by weight of another polyol having a hydroxyl functionality of 2.0 to 5.0 and a hydroxyl equivalent weight of from 90 to 500.

Polyol formulations as described herein can be prepared by making the constituent polyols individually, and then blending them together. Alternatively, polyol formulations, not including the polyester, can be prepared by forming a mixture of the respective initiator compounds, and then alkoxylating the initiator mixture to form the polyol formulations directly. Combinations of these approaches can also be used.

In another embodiment, a reaction system for production of a rigid foam is provided. The reaction system comprises (A) a polyol formulation as described above, (B) a polyisocyanate component, and (C) optionally additives and auxiliaries. Such optional additives or auxiliaries are selected from the groups consisting of dyes, pigments, internal mold release agents, surfactants, fire retardants, fillers, reinforcements, plasticizers, smoke suppressants, fragrances, antistatic agents, biocides, antioxidants, light stabilizers, adhesion promoters and combinations of these.

Suitable polyisocyanates for producing polyurethane products include aromatic, cycloaliphatic and aliphatic isocyanates. Such isocyanates are well known in the art.

Examples of suitable aromatic isocyanates include the 4,4′-, 2,4′ and 2,2′-isomers of diphenylmethane diisocyanate (MDI), blends thereof and polymeric and monomeric MDI blends, toluene-2,4- and 2,6-diisocyante (TDI) m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. In one embodiment, TDI/MDI blends are used.

Examples of aliphatic polyisocyanates include ethylene diisocyanate, 1,6-hexamethylene diisocyanate, 1,3- and/or 1,4-bis(isocyanatomethyl)cyclohexane (including cis- or trans-isomers of either), isophorone diisocyanate (IPDI), tetramethylene-1,4-diisocyanate, methylene bis(cyclohexaneisocyanate) (H₁₂MDI), cyclohexane 1,4-diisocyanate, 4,4′-dicyclohexylmethane diisocyanate, saturated analogues of the above mentioned aromatic isocyanates and mixtures thereof.

Derivatives of any of the foregoing polyisocyanate groups that contain biuret, urea, carbodiimide, allophonate and/or isocyanurate groups can also be used. These derivatives often have increased isocyanate functionalities and are desirably used when a more highly crosslinked product is desired.

For production of rigid polyurethane or polyisocyanurate materials, the polyisocyanate is generally a diphenylmethane-4,4′-diisocyanate, diphenylmethane-2,4′-diisocyanate, polymers or derivatives thereof or a mixture thereof. In one preferred embodiment, the isocyanate-terminated prepolymers are prepared with 4,4′-MDI, or other MDI blends containing a substantial portion or the 4,4′-isomer or MDI modified as described above. Preferably the MDI contains 45 to 95 percent by weight of the 4,4′-isomer.

The polyisocyanate is used in an amount sufficient to provide an isocyanate index of from 150 to 800. Isocyanate index is calculated as the number of reactive isocyanate groups provided by the polyisocyanate component divided by the number of isocyanate-reactive groups in the polyurethane-forming composition (including those contained by isocyanate-reactive blowing agents such as water) and multiplying by 100. Water is considered to have two isocyanate-reactive groups per molecule for purposes of calculating isocyanate index. For rigid polyisocyanurate foam applications, the preferred isocyanate index is generally from 180 to 600 and in a further embodiment from 200 to 400. In another embodiment, the index is 205 or greater.

It is also possible to use one or more chain extenders in the reaction system for production of polyurethane or polyisocyanurate products. The presence of a chain extending agent provides for desirable physical properties, of the resulting polymer. The chain extenders may be blended with the polyol formulation or may be present as a separate stream during the formation of the polyurethane or polyisocyanurate polymer. A chain extender is a material having two isocyanate-reactive groups per molecule and an equivalent weight per isocyanate-reactive group of less than 400, preferably less than 300 and especially from 31-125 daltons. Crosslinkers may also be included in formulations for the production of polyurethane or polyisocyanurate polymers of the present invention. “Crosslinkers” are materials having three or more isocyanate-reactive groups per molecule and an equivalent weight per isocyanate-reactive group of less than 400. Crosslinkers preferably contain from 3-8, especially from 3-4 hydroxyl, primary amine or secondary amine groups per molecule and have an equivalent weight of from 30 to about 200, especially from 50-125.

The polyols of the present invention may be utilized with a wide variety of blowing agents. The blowing agent used in the polyisocyanurate-forming composition includes at least one physical blowing agent which is a hydrocarbon, hydrofluorocarbon, hydrochlorofluorocarbon, fluorocarbon, dialkyl ether or a fluorine-substituted dialkyl ether, or a mixture of two or more thereof. Blowing agents of these types include propane, isopentane, n-pentane, n-butane, isobutane, isobutene, cyclopentane, dimethyl ether, 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea) and 1,1,1,3,3-pentafluoropropane (HFC-245fa). The hydrocarbon and hydrofluorocarbon blowing agents are preferred. Other blowing agents which may be used, include for example, formic acid, methyl formate, carbamates and adducts thereof, carbon dioxide, acetone, methylal or hydrofluorolefin. A combination of blowing agents may be used. In a further embodiment, a hydrocarbon blowing agent is used. It is generally preferred to further include water in the formulation, in addition to the physical blowing agent.

Blowing agent(s) are preferably used in an amount sufficient such that the formulation cures to form a foam having a molded density of from 16 to 160 kg/m³, preferably from 16 to 64 kg/m³ and especially from 20 to 48 kg/m³. To achieve these densities, the hydrocarbon or hydrofluorocarbon blowing agent conveniently is used in an amount ranging from about 10 to about 40, preferably from about 12 to about 35, parts by weight per 100 parts by weight polyol(s). Water reacts with isocyanate groups to produce carbon dioxide, which acts as an expanding gas. Water is suitably used in an amount within the range of 0.5 to 3.5, preferably from 1.0 to 3.0 parts by weight per 100 parts by weight of polyol(s).

The reaction system for forming the polyisocyanurate typically will include at least one catalyst for the reaction of the polyol(s) and/or water with the polyisocyanate. Suitable urethane-forming catalysts include those described by U.S. Pat. No. 4,390,645 and in WO 02/079340, both incorporated herein by reference. Representative catalysts include tertiary amine and phosphine compounds, chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt.

Tertiary amine catalysts are generally preferred. Among the tertiary amine catalysts are dimethylbenzylamine (such as DESMORAPID® DB from Rhine Chemie), 1,8-diaza (5,4,0)undecane-7 (such as POLYCAT® SA-1 from Air Products), pentamethyldiethylenetriamine (such as POLYCAT® 5 from Air Products), dimethylcyclohexylamine (such as POLYCAT® 8 from Air Products), triethylene diamine (such as DABCO® 33LV from Air Products), dimethyl ethyl amine, n-ethyl morpholine, N-alkyl dimethylamine compounds such as N-ethyl N,N-dimethyl amine and N-cetyl N,N-dimethylamine, N-alkyl morpholine compounds such as N-ethyl morpholine and N-coco morpholine, and the like. Other tertiary amine catalysts that are useful include those sold by Air Products under the trade names DAB CO® NE1060, DABCO® NE1070, DABCO® NE500, DABCO® TMR 30, POLYCAT® 1058, POLYCAT® 11, POLYCAT® 15, POLYCAT® 33, POLYCAT® 41 and DABCO® MD45, and those sold by Huntsman under the trade names ZR 50 and ZR 70. In addition, certain amine-initiated polyols can be used herein as catalyst materials, including those described in WO 01/58976 A. Mixtures of two or more of the foregoing can be used.

The catalyst is used in catalytically sufficient amounts. For the preferred tertiary amine catalysts, a suitable amount of the catalysts is from about 0.3 to about 2 parts, especially from about 0.3 to about 1.5 parts, of tertiary amine catalyst(s) per 100 parts by weight of the polyol(s).

For the formation of polyisocyanurates, a trimerization catalyst may be included in the total reaction system for producing a rigid foam. Such trimerization catalyst, include, for example tris(dialkylaminoalkyl)-s-hexahydrotriazines such as 1,3,5-tris(N,N-dimethylaminopropyl)-s-hexahydrotriazine; DAB CO TMR 30, DAB CO K 2097; DABCO K15, potassium acetate, potassium octoate; POLYCAT 43, POLYCAT 46, DABCO TMR, DABCO® TMR-2, DABCO® TMR-3, DABCO® TMR-4, DAB CO® TMR-5, CURITHANE 52, tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, in some embodiments, pendant hydroxyl groups. The amount of trimerization catalysts, when used, is generally from 0.5 to 5 weight percent of the total polyol. In further embodiments the level of trimerization catalyst will be at least 1 weight percent based on the total polyol component up to 4 weight percent.

The reaction system for forming the polyisocyanurate may also contain at least one surfactant, which helps to stabilize the cells of the composition as gas evolves to form bubbles and expand the foam. Examples of suitable surfactants include alkali metal and amine salts of fatty acids such as sodium oleate, sodium stearate sodium ricinolates, diethanolamine oleate, diethanolamine stearate, diethanolamine ricinoleate, and the like: alkali metal and amine salts of sulfonic acids such as dodecylbenzenesulfonic acid and dinaphthylmethanedisulfonic acid; ricinoleic acid; siloxane-oxalkylene polymers or copolymers and other organopolysiloxanes; oxyethylated alkylphenols (such as Tergitol NP9 and Triton X100, from The Dow Chemical Company); oxyethylated fatty alcohols such as Tergitol 15-S-9, from The Dow Chemical Company; paraffin oils; castor oil; ricinoleic acid esters; turkey red oil; peanut oil; paraffins; fatty alcohols; dimethyl polysiloxanes and oligomeric acrylates with polyoxyalkylene and fluoroalkane side groups. These surfactants are generally used in amount of 0.01 to 6 parts by weight based on 100 parts by weight of the polyol.

Organosilicone surfactants are generally preferred types. A wide variety of these organosilicone surfactants are commercially available, including those sold by Goldschmidt under the TEGOSTAB® name (such as TEGOSTAB® B-8462, B8427, B8433 and B-8404 surfactants), those sold by OSi Specialties under the NIAX® name (such as NIAX® L6900 and L6988 surfactants) as well as various surfactant products commercially available from Air Products and Chemicals, such as DC-193, DC-198, DC-5000, DC-5043 and DC-5098 surfactants.

In addition to the foregoing ingredients, the polyisocyanurate-forming reaction system may include various auxiliary components such as fillers, colorants, odor masks, flame retardants, biocides, antioxidants, UV stabilizers, antistatic agents, viscosity modifiers and the like.

Examples of suitable flame retardants include phosphorus compounds, halogen-containing compounds and melamine.

Examples of fillers and pigments include calcium carbonate, titanium dioxide, iron oxide, chromium oxide, azo/diazo dyes, phthalocyanines, dioxazines, recycled rigid polyurethane or polyisocyanurate foam and carbon black.

Examples of UV stabilizers include hydroxybenzotriazoles, zinc dibutyl thiocarbamate, 2,6-ditertiarybutyl catechol, hydroxybenzophenones, hindered amines and phosphites.

Except for fillers, the foregoing additives are generally used in small amounts. Each may constitute from 0.01 percent to 3 percent of the total weight of the polyisocyanurate-forming reaction system. Fillers may be used in quantities as high as 50% of the total weight of the polyisocyanurate-forming reaction system.

The polyisocyanurate-forming reaction system is prepared by bringing the various components together under conditions such that the polyol(s) and isocyanate(s) react, the blowing agent generates a gas, and the composition expands and cures. All components (or any sub-combination thereof) except the polyisocyanate can be pre-blended into a formulated polyol composition if desired, which is then mixed with the polyisocyanate when the foam is to be prepared. The components may be preheated if desired, but this is usually not necessary, and the components can be brought together at about room temperature (˜22° C.) to conduct the reaction. It is usually not necessary to apply heat to the composition to drive the cure, but this may be done if desired, too.

The invention is particularly useful in production of composite elements which include at least one facing layer of a rigid or flexible material and a core layer of a rigid foam. In another embodiment, the composite element includes at least two outer layers of a rigid or flexible material with the core layer of rigid foam sandwiched therebetween.

For the outer layers or facings it is in principle possible to use any of the conventionally used flexible or rigid facings, such as aluminum (lacquered and/or anodized), steel (galvanized and/or lacquered), copper, stainless steel, and non-metals, such a non-woven organic fibers, plastic sheets (e.g. polystyrene), plastic foils (e.g. PE foil), timber sheets, glass fibers, impregnated cardboard, paper, or mixtures of laminates of these. It is generally preferable to use metallic facings, particularly made of aluminum and/or steel. The thickness of the facings is generally from 200 μm to 5 mm. In further embodiments, the thickness is greater than 300 μm or greater than 400 μm. In further embodiments, the thickness is less than 3 mm or less than 2 mm. An example of commercially available facings is Galvalumne™ metal facings.

Other exemplary methods for applying the polyisocyanurate foams described herein are described in U.S. Pat. No. 7,540,932, US 2007/0246160, WO 2008/018787 and WO 2009/077490.

In certain embodiments, it may be advantageous to apply one or more adhesion promoting layers prior to application of the polyisocyanurate formulation to improve adhesion between the polyisocyanurate formulation and other portions of the composite element. The adhesion promoting layer may be based on polyurethane or polyisocyanurate. The adhesion promoting layer may be obtained by reacting (a) polyisocyanates with (b) compounds having two hydrogen atoms reactive toward isocyanate.

The foam layer will generally be from 2 cm to 25 cm in thickness. In other embodiments foam layer is from 2.5 to 21 cm and in a particular embodiment from 6 to 16 cm. The double-belt conveyor will generally be heated at a temperature in the range of 35° C. to 75° C. Preferably the double-belt conveyor will be at temperatures from 45° C. to 60° C.

Applications for the produced panels include use in wall, roof and interior partition construction.

### Examples

Objects and advantages of the embodiments described herein are further illustrated by the following examples. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

A description of the raw materials used in the examples is as follows.

VORANOL™ 360 is a sucrose/glycerin initiated polyether polyol having a functionality of about 4.5 and a hydroxyl number of about 460 available from The Dow Chemical Company.

TERATE®-2031 polyol is a polyester polyol based on dimethyl terephthalate available from Invista.

Polyester A is a polyester polyol based on terephthalic acid, diethylene glycol, glycerin, and polyethylene glycol 200 as described herein.

TCPP, Tris(chloroisopropyl) phosphate, is a low viscous and low acidic flame retardant additive available from Supresta.

DABCO® DC 193 is a silicon surfactant available from Air Products (DAB CO is a trademark of Air Products).

DABCO® K-15 catalyst is a catalyst solution of potassium-octoate in diethylene glycol available from Air Products.

ARALDITE® CY179 resin is a multifunctional resin of alicyclic diepoxy carboxylate available from Huntsman Advanced Materials Inc.

POLYCAT® 8 is a N,N-dimethylcyclohexyl amine catalyst, available from Air Products.

HFC-245fa, 1,1,1,3,3-pentafluoropropane, is a blowing agent available under the trade name ENOVATE® from Honeywell.

PAPI™ 580N polymeric MDI is a polymethylene polyphenylisocyanate that contains MDI available from The Dow Chemical Company.

TYZOR® AA-105 (acetylacetonates) catalyst which is a reactive titanium acetylacetonate chelate commercially available from DuPont.

The properties of the polyester polyols and formulations incorporating such polyesters for producing a polyisocyanurate foam are given in Tables 1 and 2 respectively. The raw materials shown in Table 1 are loaded into a reactor equipped with a nitrogen inlet tube, pneumatic stirrer, thermometer and condenser. Heat is applied and the contents of the reactor raised to 230-235° C. At a temperature of 210° C., a titanium acetylacetonate catalyst (Tyzor AA-105 from Dorf Ketal) is charged at 50 ppm and flow of nitrogen is applied. The mixture is held at 230-235° C. for 5 hours. The polyester at this point has an acid number below 2.0 mgKOH/g and the properties described in Table 1.

TABLE 1
Polyester Polyol Properties.

| | Terate 2031^{a} | Polyester A |
|---|---|---|
| Raw Material Composition (wt. %) | | |
| TPA | | 37 |
| Glycerin | | 8 |
| DEG | | 17 |
| PEG 200 | | 38 |
| OH | 310 | 315 |
| Viscosity @25° C. (cP) | 12,000 | 4,000 |
| functionality | 2.3 | 2.4 |

^{a}Commercial polyol commonly used to make flame retardant polyisocyanurate foams, exact composition is unknown.

TABLE 2
Formulations.

| Components | C1 | Ex. #1 |
|---|---|---|
| Voranol 360 | 13.00 | 12.94 |
| Terate-2031 (DMT) | 52.03 | |
| Polyester A | | 51.77 |
| TCPP | 11.23 | 11.34 |
| Dabco DC 193 | 1.52 | 1.52 |
| Water | 0.57 | 0.57 |
| Dabco K-15 | 1.90 | 1.92 |
| CY 179 | 0.03 | 0.03 |
| Polycat 8 | 0.25 | 0.25 |
| HFC-245fa | 19.47 | 19.66 |
| Total | 100.00 | 100.00 |
| Papi-580N | 149.7 | 152.2 |
| Total | 249.7 | 252.2 |

The properties of the produced polyisocyanurate foams are given in Table 3.

TABLE 3
Results.

| Properties | C1 | Ex. #1 |
|---|---|---|
| Mean (Cream time (seconds)) | 15 | 14 |
| Mean (Gel Time (seconds)) | 40 | 41 |
| Density (lbs/ft³) | 2.3 | 2.2 |
| Mean (Green Strength (kg-force)) | | |
| 2 minutes | 92.7 | 124.4 |
| 4 minutes | 209.6 | 233.4 |
| 5 minutes | 243.5 | 279.1 |
| 6 minutes | 283.5 | 306.6 |
| 7 minutes | 285.3 | 323.6 |
| 8 minutes | 312.2 | 323.2 |
| 10 minutes | 367.3 | 363.4 |
| 12 minutes | 395.6 | 391.4 |

For green strength testing, a free rise sample was hand mixed and poured into an 8 inch (30.3 cm) long by 8 inch (20.3 cm) wide by 9.5 inch (24.1 cm) high wood mold (room temperature). Sufficient material was mixed to produce a foam such that the finished sample rises sufficiently to form a flat surface on the sides of at least 8 inches (20.3 cm) high. The foam was allowed to cure in the mold until 1 minute before the desired testing time, i.e., 29 minutes for a 30-minute test result.

The green strength test procedure was conducted on an Instron 5566 Extra wide Materials Testing System. The load cell (UK 537/2,000 lb) was mounted in a crosshead which rides in the vertical guides of the load frame. The test specimen was placed on a test platen and was then compressed by an indenter foot 8 inches (20.3 cm) in diameter which was affixed to the load cell.

To begin the green strength test, the foam sample was positioned horizontally (compared to the pour) and centered on the Instron test platen. At 15 seconds prior to the desired time [29 min. 45 sec. after removal from the mold for a 30-minute test], the test was started. This initiated the Instron to lower the crosshead from the beginning 228.6 mm (9 inch (22.9 cm)) height position at a rate of 100 mm/min until the load cell made contact with the foam sample. The crosshead continued to lower until a force of 8.9 N (2.0 lbf) was reached, at which time the thickness was automatically recorded. Next, the crosshead lowered again; this time at a rate of 305 mm/min until a 25.4 mm compression was obtained (compared to the 2.0 lbf thickness) at which time the maximum compression load (Green Strength) was automatically recorded. Green strength values give an indication of a molded or cast products ability to withstand handling, mold ejection, and machining before it is completely cured or hardened.

The foams produced using the example #1 formulation depicted in Table 2 resulted in a polyisocyanurate foam having a similar reactive profile but with a higher green strength during the typical time frame in which a double faced panel would be processed through a double-belt laminating system (e.g., less than 8 minutes). This higher green strength at similar reactivity will result in a panel having an increased “hardness” at the end of the customer's line and reduced potential for post-expansion, shrinkage, deformation and damage from stacking and handling.

While the foregoing is directed to embodiments of the invention, other and further embodiments of the invention may be devised without departing from the basic scope thereof.

1. A polyester which is the reaction product of at least:
(a) an aromatic component comprising 80 mole percent or greater of terephthalic acid;
(b) at least one polyether polyol having a nominal functionality of 2, a molecular weight of 150 to 1,000 and a polyoxyethylene content of at least 70% by weight of the polyether polyol;
(c) at least one glycol different than (b) having a nominal functionality of 2 and a molecular weight from 60 to 250; and
(d) at least one polyol having a molecular weight of 60 to 250 and a nominal functionality of at least 3;
wherein a, b, c, and d are present in the reaction on a percent weight basis of 20 to 60 weight percent of (a), 20 to 50 weight percent of (b), 10 to 30 weight percent of (c), and 5 to 20 weight percent of (d).

2. The polyester of claim 1, wherein the aromatic component comprises 85 mole percent or greater of terephthalic acid.

3. The polyester of claim 1, wherein component (c) is ethylene glycol, diethylene glycol, or oxyalkylene glycol of the formula: 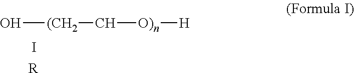
where R is hydrogen or a lower alkyl of 1 to 4 carbon atoms and n is selected to give a molecular weight of 250 or less

4. The polyester of claim 3, wherein component (c) is diethylene glycol and polyethylene glycol having a molecular weight of 200 or less.

5. The polyester of claim 1, wherein component (d) is glycerin.

6. The polyester of claim 1, wherein the polyester has a functionality between 2.3 and 2.7.

7. The polyester of claim 6, having a viscosity less than 15,000 cps (mPa*s) at 25° C. as measured by UNI EN ISO 3219.

8. A reaction system for production of a rigid foam comprising:
(A) a polyol formulation comprising:
(1) a polyester which is the reaction product of:
(a) an aromatic component comprising 80 mole percent or greater of terephthalic acid;
(b) at least one polyether polyol having a nominal functionality of 2, a molecular weight of 150 to 1,000 and a polyoxyethylene content of at least 70% by weight of the polyether polyol;
(c) at least one glycol other than (b) having a nominal functionality of 2 and a molecular weight from 60 to 250; and
(d) at least one polyol having a molecular weight of 60 to 250 and a nominal functionality of at least 3;
wherein (a), (b), (c), and (d) are present in the reaction on a percent weight basis of 20 to 60 weight percent of (a), 20 to 50 weight percent of (b), 10 to 30 weight percent of (c), and 5 to 20 weight percent of (d);
(B) one or more polyisocyanate components;
(C) blowing agents;
(D) catalysts; and
(E) optionally additives and auxiliaries.

9. The reaction system of claim 8 wherein the polyisocyanate is in an amount sufficient to provide an isocyanate index of from 150 to 800.

10. The reaction system of claim 9, wherein the one or more polyisocyanate components (B) is a polymethylene polyphenylisocyanate containing methylene diphenyl diisocyanate (MDI).

11. The reaction system of claim 10, wherein the polyol formulation further comprises:
(2) an additional polyether polyol different than (b), (c), and (d) having a functionality of 2 to 8 and a molecular weight of 100 to 2,000.

12. A composite element comprising:
i) a facing layer;
ii) a rigid foam comprising the reaction product of:
(A) a polyol formulation comprising:
(1) a polyester which is the reaction product of:
(a) an aromatic component comprising 80 mole percent or greater of terephthalic acid;
(b) at least one polyether polyol having a nominal functionality of 2, a molecular weight of 150 to 1,000 and a polyoxyethylene content of at least 70% by weight of the polyether polyol
(c) at least one glycol different then (b) having a nominal functionality of 2 and a molecular weight from 60 to 250; and
(d) at least one polyol having a molecular weight of 60 to 250 and a nominal functionality of at least 3;
wherein (a), (b), (c), and d are present in the reaction on a percent weight basis of 20 to 60 weight percent of (a), 20 to 50 weight percent of (b), 10 to 30 weight percent of (c), and 5 to 20 weight percent of (d);
(B) a polyisocyanate component;
(C) blowing agents;
(D) catalysts; and
(E) optionally additives and auxiliaries.

13. The composite element of claim 12, wherein the polyol formulation further comprises:
(2) an additional polyether polyol different than (b), (c), and (d) having a functionality of 2 to 8 and a molecular weight of 100 to 2,000.

14. The composite element of claim 13, wherein the polyol formulation comprises:
from 20 to 90 wt. % of the polyester; and
from 10 to 80 wt. % of the additional polyether polyol.

15. The composite element of claim 14, further comprising:
(iii) an additional facing layer, wherein the rigid foam is formed between the facing layer and the additional facing layer.
